(19) United States
(12) Patent Application Publication
(10) Pub. No.: US 2009/0179818 A1
(43) Pub. Date: Jul. 16, 2009

(54) Antenna formed of multiple planar arrayed loops

(76) Inventors: Mark Rhodes, West Lothian (GB); Brendan Hyland, Edinburgh (GB)

Correspondence Address: Goodwin Procter LLP;Attn: Patent Administrator, 135 Commonwealth Drive, Menlo Park, CA, 94025-1105, US

(21) Appl. No.: 12/338,011

(22) Filed: Dec. 18, 2008

Related U.S. Application Data
(60) Provisional application No. 61/014,796, filed on Dec. 19, 2007.

(30) Foreign Application Priority Data
Dec. 19, 2007 (GB) 0724704.2

(51) Int. Cl. H01Q 21/06

(52) U.S. Cl. 343/867

(57) ABSTRACT

A magnetic and/or magneto-electric antenna that has a plurality of conducting loops, two or more of the loops being driven by separate drivers, wherein the loops are positioned side by side in a net-like layout.

### CROSS-REFERENCE TO RELATED APPLICATIONS

This application claims the benefit of U.S. Ser. No. 61/014,796 filed Dec. 19, 2007, and GB 0724704.2, filed Dec. 19, 2007, both of which applications are fully incorporated herein by reference.

### INTRODUCTION

The present invention relates to electromagnetic and/or magneto-inductive antennas formed using multiple separate conducting loops.

### BACKGROUND

FIG. 1 shows a magnetic loop antenna that has a single magnetic loop 1 connected to a single drive circuit 2, the loop being formed to enclose a significant area, usually circular in shape for convenience and maximum efficiency. The output signal from driver 2 may be derived from an input from signal source 3, the characteristics of which are appropriate to the system and antenna of which it is a part. The arrows illustrate flow of current round the loop at an instant in time. For such a loop antenna, which has known dimensions and number of turns and is driven by an alternating voltage of a known frequency, there will be some maximum drive voltage that cannot be exceeded for practical reasons. Consequently, due to the particular inductive reactance of the loop, there will be some corresponding resultant maximum loop current.

Magnetic loop antennas can be used in a number of applications, but are particularly useful in underwater electromagnetic and/or magneto-inductive communications systems where relatively low signal frequencies are needed to reduce signal attenuation. Such magnetic loops generate an alternating magnetic field. The strength of the magnetic field is commonly defined by the magnetic moment. The magnetic moment is directly proportional to each of three parameters: loop area, loop current, and number of loop turns. Equivalently, it may be stated that the magnetic moment is proportional to both the ampere-turn product of the loop and to the area of the loop. For signal detection at greatest distance, the largest achievable magnetic moment is desirable. Thus, it is usually desirable that as many as possible of the three partially related parameters are designed to be as large as practical circumstances will permit.

In arranging to achieve a large magnetic moment, particular antenna and transmitter system designs may be constrained in practice by, for example: the practical maximum size (usually diameter) of antenna loop; the inductive reactance of the loop, which at a particular frequency is determined principally by the number of turns and the diameter; and the maximum drive voltage. The otherwise desirable goals of a large number of turns and of a large diameter both have the effect of increasing the inductance of the loop. Any given alternating drive voltage will result in current in the loop inversely proportional to the inductance assuming the loop resistance is small. Thus, the desirable effects resulting from a larger area of loop and more turns tend to be counteracted by a lesser loop current due to increased inductive reactance. Whilst using a larger voltage can increase the drive current, there are practical limits to the drive voltage that may be used.

### SUMMARY OF THE INVENTION

According to one aspect of the present invention, there is provided a means of increasing the magnetic moment of a loop antenna by increasing the alternating signal current, which flows without need for greater drive voltage. The area available for deployment of an antenna is occupied by a number of smaller loops which can each be driven by a less demanding transmitter circuit design than that required by a single larger loop.

Some systems of loop antennas and associated transmitters used for the example purpose of underwater communication are discussed in our co-pending patent application, “Underwater Communication System” PCT/GB2006/002123, the contents of which are incorporated herein by reference. Typical means of implementing and applying magnetic loop antennas are described therein, and not repeated here. Although without the enhancements provided by this invention, the general principles of low frequency loop antennas are also known elsewhere.

### BRIEF DESCRIPTION OF THE DRAWINGS

Various aspects of the invention will now be described by way of example only and with reference to the accompanying drawings, of which:

FIG. 1 shows a conventionally driven loop that does not benefit from the arrangement described in this invention;

FIG. 2 is an example of a modified circular loop antenna which has a number of sub-loops each driven by a separate drive circuit;

FIG. 3 shows a system of multiple antennas, each driven by a separate driver amplifier and

FIG. 4 shows a system of multiple antennas, each connected to a receive amplifier.

### DETAILED DESCRIPTION OF THE DRAWINGS

The present invention relates to magnetic and/or magneto-inductive loop antennas in which the effective conductive loop is divided into two or more loops, and separate drive circuits drive currents in individual loops. For ease of description, the turns of the coil are usually substantially in a plane and approximately of the same diameter. Where such an antenna is intended for relatively low frequency operation, the loop diameter, although probably designed to be as large as practicable, will still be very small in relation to the wavelength of the signal being transmitted. For example, with an alternating signal drive voltage of frequency (say) 1 kHz or 10 kHz, a loop antenna diameter of 2 m is proportionately very small in relation to the signal wavelength. Thus, currents at all points of the loop may be considered mutually in phase.

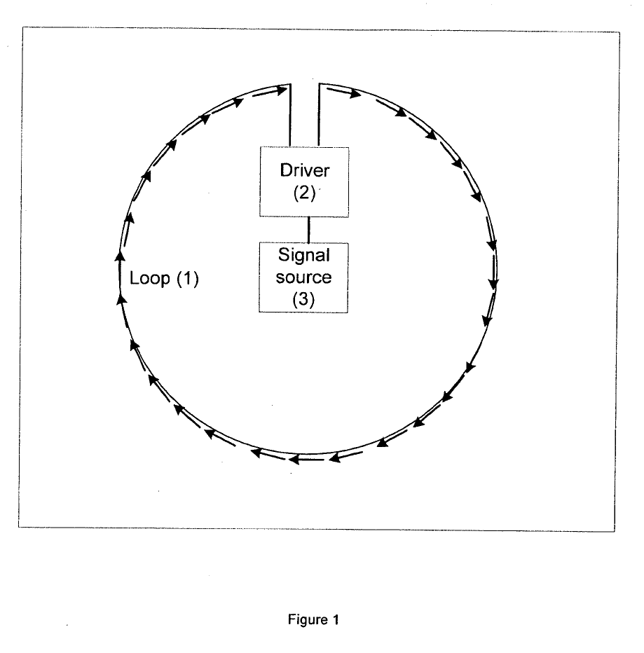

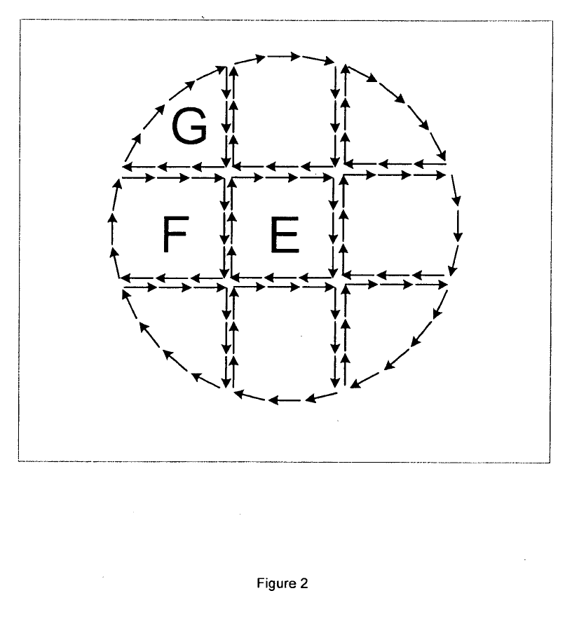

FIG. 2 illustrates a composite loop, of the same overall dimensions as that of FIG. 1, divided into a number of smaller loops, in this case nine smaller loops, deployed in a single plane, each comprising a proportion of the original area. Each of the nine sub-loops is driven by its own driver circuit. The alternating signals from all of the driver circuits are arranged to be substantially and mutually in phase. The arrows illustrate the flow of current at any instant of time. For sake of simplicity, consider that each sub-loop driven by a constant current source. The sub-loops will be driven in phase and arranged so the current circulates in the same rotational direction in all sub-loops of a composite antenna as shown in FIG. 2. In this arrangement the sub-loop elements at the perimeter of the composite antenna will each have current flowing in the same rotational sense to mimic the effect of a single large loop.

While this principle is illustrated here with a nine loop system the sub-loop technique described here is equally applicable to a system of two or more loops. While the technique is represented in diagrammatic form here by indicating single turn sub-loops it is equally applicable to an assembly of multi-turn loops.

Elements of each sub-loop that do not form part of the boundary of the resulting composite antenna should be arranged in close contact with the conductor of neighbouring sub-loops and arranged to be incrementally parallel to a neighbouring current element. Sub-loops are attached to neighbouring loops resulting in a net-like arrangement. Sub-loops are electrically insulated from their neighbours so that the conductors of neighbouring loops are arranged to be in close contact but separated by in electrically insulating material.

In FIG. 2, loop E illustrates an embedded sub-loop with no component at the periphery. The arrows indicate instantaneous flow of equal currents and it can be seen that each element of loop E has a neighbouring current element which is equal in amplitude but of opposite direction. In this arrangement, the electromagnetic fields generated by each element of loop E are exactly cancelled by those from adjacent current elements. The remaining eight sub-loops all have partial field cancellation in a similar manner. For example, loop F has cancelling currents along 3 of its 4 sides, while loop G has cancelling currents on 2 of its 3 sides. It can readily be seen that the combined effect of the nine sub-loops is exactly equivalent to a single loop, of the same dimensions as the array periphery, driven with the same current. The main practical advantage of the array arrangement is in the reduced voltage required to drive the required current though each of the sub-loops compared to a single large loop.

While FIG. 2 illustrates sub-loops arranged in a common plane this is not an essential feature of the present system. Sub-loops must be arranged with their conductors incrementally in close contact with elements of neighbouring sub-loops and this requirement results in sub-loops deployed adjacently to form a contiguous enclosed surface. This arrangement is analogous to a net structure. The resulting composite surface may have various topologies. For example sub-loops may be deployed to form a composite conformal antenna deployed over part of a cylindrical hull.

Loop inductance is a function of area and number of turns squared. The array antenna sub-loops are easier to drive not only because of the reduced sub-loop area, but also due to the current cancelling effect described above. Loop E will have no geometrical net inductance since its magnetic field is exactly balanced by adjacent loops. Sub-loop conductors exhibit a parasitic inductance independent of their looped deployment due to the intrinsic inductance of a wire. The current source at loop E merely drives current through the remaining loop resistance, and parasitic reactance, which can be arranged to be quite small. Loop F has cancelling adjacent currents along 3 of its 4 sides so its total inductance will be approximately ⅓ that of an isolated loop of the same construction with a proportional reduction in the required drive voltage required from its current source. A similar inductance occurs for each sub-loop depending on the local geometry, but in each case, reducing the loop inductance compared with an equivalent isolated loop.

As a result the magnetic moment of the combined set of sub-loops driven in the manner described may be achieved with a smaller drive voltage, at each of the sub-loop drivers, than that required to drive an equivalent large loop or a loop of equal dimensions driven in isolation without the effects seen from its neighbours in the array.

Alternatively, we can consider a driver design, which has practically limited maximum drive voltage. The magnetic moment of the array can be greater than that of a single larger loop since we can drive a greater current through the loop periphery by deploying multiple driver circuits to drive each sub-loop with a greater current. A system employing this architecture will have enhanced performance characteristics proportional to the resultant increased magnetic moment.

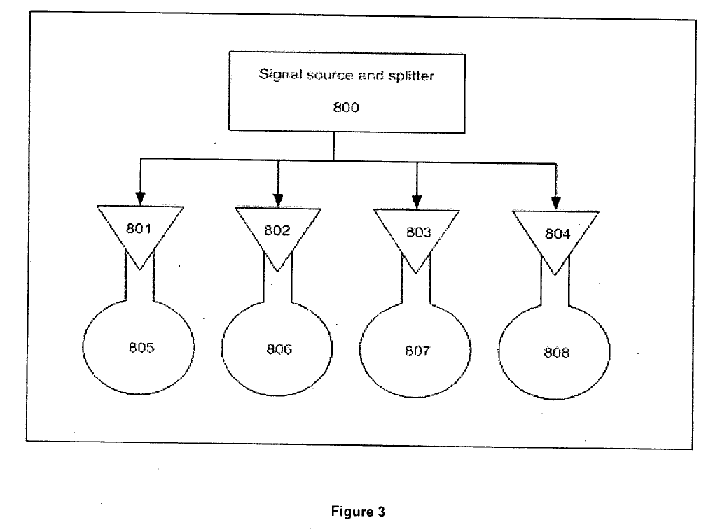

FIG. 3 shows a system of multiple antennas 805, 806, 807 and 808 each driven by a separate driver amplifier 801, 802, 803 and 804 illustrated in schematic form. A common signal source is divided by splitter 800 to feed each transmit amplifier. This system can be used to drive any of the multiple antenna systems described in this application.

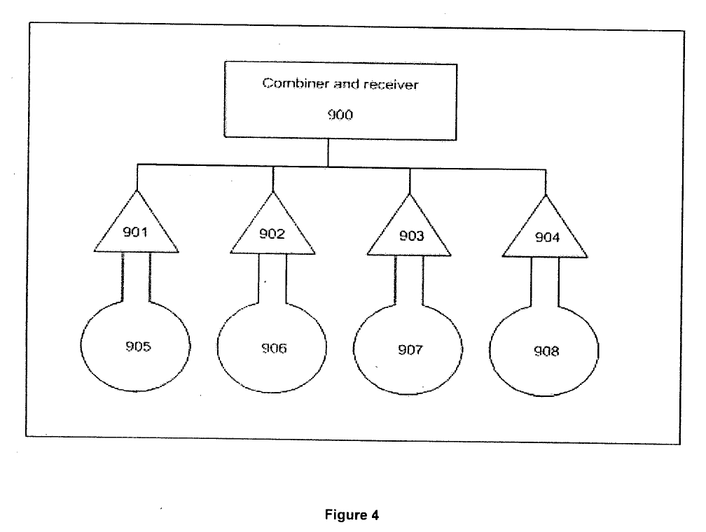

FIG. 4 shows a system of multiple antennas 905, 906, 907 and 908, each connected to a receive amplifier 901, 902, 903 and 904 illustrated in schematic form. The receive amplifier outputs are combined by the combiner and receiver 900. This system can be used to combine the received signals from the multiple antenna systems described in this application.

Those familiar with electromagnetics will understand that the foregoing is but one possible example of the principle according to this invention. In particular, to achieve some or most of the advantages of this invention, practical implementations may not necessarily be exactly as exemplified and can include variations within the scope of the invention. For example, there may be any number of sub-loops; the sub-loops may not be closely spaced, aligned in a single plane or completely coupled; the currents in the sub-loops may not necessarily be equal; the currents may not be exactly in phase; the number of turns in the sub-loops may not be the same; and the magnetic moment may be enhanced by the introduction of ferromagnetic core material within the loops. Those skilled in electrical engineering will understand the practical compromises, which may be required in implementations for particular applications, while still achieving worthwhile greater magnetic moment without necessarily using greater drive voltage.

The signal source is not described because the principles of this invention are independent of the application to which the antenna is put. In many implementations, the driver may be a circuit providing an output, which is an alternating current source whose characteristic may be of complex form but is dependent on the signal source. The driver may not necessarily be a current source, and could be a voltage source or have some other source impedance, but those skilled in circuit design will readily understand how to provide a driver circuit with characteristics suitable to generate the current required in the antenna loop.

A skilled person will appreciate that variations in implementation and application of the disclosed example arrangements are possible without departing from the essence of this invention, and variations may still derive full or partial advantage from it. Such variations may include, but are not limited to, those previously outlined. Furthermore, in those applications of this transmitting antenna that also require a receiving function, the antenna loops also may be used conveniently and advantageously as an electromagnetic or magneto-electric receive antenna. Applications of this invention are not limited to communication systems but may also include others requiring a large alternating magnetic moment. These include but are not limited to navigation systems, direction finding systems and systems for detecting the presence of objects.

1. A magnetic and/or magneto-electric antenna that has a plurality of conducting loops, two or more of the loops being driven by separate drivers, wherein the loops are positioned side by side in a net-like layout.

2. An antenna as claimed in claim 1 wherein at least two or more of the loops co-operate to define a substantially continuous outer periphery.

3. An antenna as claimed in claim 1 wherein at least two or more of the loops co-operate to define a substantially continuous outer periphery and the drivers are such that current circulates round each loop at the periphery in the same direction.

4. An antenna as claimed in claim 1 wherein one or more loops is enclosed by the loops that define an outer periphery.

5. An antenna as claimed in claim 1 wherein the drivers are arranged to cause current to circulate round each loop in the same direction.

6. An antenna as claimed in claim 1 wherein all the loops lie in substantially the same plane.

7. An antenna as claimed in claim 1 wherein the loops co-operate to form a larger, substantially circular loop.

8. An antenna as claimed in claim 1 wherein every loop is driven by a separate driver.

9. An antenna as claimed in claim 1 wherein the loops are formed from single or multiple turns.

10. An antenna as claimed in claim 1 wherein two or more groups of loops are driven by separate drivers

11. An antenna as claimed in claim 1 wherein the loops are used singly or in combination to receive a signal.

12. An antenna as claimed in claim 1 wherein the loops are used singly or in combination to receive a signal and the signal received from each loop is combined substantially in phase.

13. An antenna as claimed in claim 1 wherein the conductor loops are in close proximity and/or closely coupled.

14. An antenna as claimed in claim 1 wherein the conductor loops are electrically insulated from neighbouring loops.

15. An antenna as claimed in claim 1 wherein the loops are used singly or in combination to transmit signal currents.

16. An antenna as claimed in claim 1, wherein the loops are used singly or in combination to transmit signal currents and the transmit signal in each loop is arranged to be substantially in phase mutually.

17. An antenna as claimed in claim 1, wherein the loops are used singly or in combination to transmit signal currents and the transmit signal in each loop is arranged to rotate around the loop in the same sense as the other sub-loops that form a composite antenna.

18. An antenna as claimed in claim 1 wherein the output of one or more of the driver circuits is electrical voltage.

19. An antenna as claimed in claim 1 wherein a high permeability core material passes through the centre of one or more of the loops.

20. An antenna as claimed in claim 1 wherein the output of one or more driver circuit is an electrical current.

21. An antenna as claimed in claim 1 wherein one or more of the driver circuits is a source with an impedance that has real and/or imaginary parts.

22. An antenna as claimed in claim 1 incorporated in a communications system.

23. An antenna as claimed in claim 1 incorporated in a navigation system or a direction finding system or a system for detecting the presence of objects or any combination of these.

24. An antenna as claimed in claim 1 wherein the loops are fixed in place in the net-like layout.

25. An antenna as claimed in claim 1 wherein the loops are attached to each other at their edges, so as to form a net-like structure.

26. An antenna as claimed in claim 1 wherein the loops are attached to each other at their edges, so as to form a net-like structure, wherein the structure is flexible.

27. An antenna according to claim 1 wherein the drivers are arranged such that the same current amplitude flows in each sub-loop.
